(19) United States
(12) Patent Application Publication
(10) Pub. No.: US 2025/0144830 A1
(43) Pub. Date: May 8, 2025

(54) OSCILLATING TOOL

(71) Applicant: Black & Decker Inc., New Britain, CT (US)

(72) Inventors: Nicholas A MONDICH, Towson, MD (US); Bin ZHAO, Jiangsu (CN); Jiang Feng WANG, Jiangsu (CN)

(73) Assignee: Black & Decker Inc., New Britain, CT (US)

(21) Appl. No.: 18/924,512

(22) Filed: Oct. 23, 2024

Related U.S. Application Data
(60) Provisional application No. 63/597,023, filed on Nov. 8, 2023.
(60) Provisional application No. 63/662,024, filed on Jun. 20, 2024.
(60) Provisional application No. 63/637,668, filed on Apr. 23, 2024.

(51) Int. Cl. B26B 19/12

(52) U.S. Cl. CPC B26B 19/12

(57) ABSTRACT

An oscillating tool includes a housing; a motor in the housing; a first blade clamp; a blade clamp shaft; and a second blade clamp on the blade clamp shaft. The blade clamp shaft includes a latching portion to engage a seat. The oscillating tool also includes a blade clamp spring configured to bias the latching portion into engagement with the seat.

### CROSS-REFERENCE TO RELATED APPLICATIONS

This application claims benefit of Provisional Patent Application No. 63/597,023 filed Nov. 8, 2023, and claims benefit of Provisional Patent Application No. 63/662,024 filed Jun. 20, 2024, and claims benefit of Provisional Patent Application No. 63/637,668 filed Apr. 23, 2024. The entire contents of each are incorporated herein by reference.

### BACKGROUND

The present disclosure relates to power tools and accessory clamping mechanisms for power tools, for example an oscillating power tool.

### SUMMARY

Aspects of the present disclosure relate to example embodiments of a power tool, for example, an oscillating power tool.

According to an aspect, an example embodiment of an oscillating tool, includes: a housing; a motor in the housing; a clamp assembly operatively driven by the motor in an oscillating motion about an oscillating axis, the clamp assembly comprising a first blade clamp and a second blade clamp opposing the first blade clamp, the clamp assembly configured to selectively hold a power tool accessory between the first blade clamp and the second blade clamp; a yoke operatively coupled to the second blade clamp and configured to move the second blade clamp relative to the first blade clamp; a clamp lever connected to the yoke and configured to drive the yoke; a headbox; an output spindle at least partially disposed in the headbox. The yoke may extend along a first side of the headbox and a second side of the headbox opposite the first side of the headbox.

The yoke may have a generally upside-down U-shape.

The clamp may be rotatable about a pivot axis.

The pivot axis may be rearward of the oscillating axis.

The first blade clamp may be formed integrally as one piece with the output spindle.

The clamp lever may be disposed at an underside of the housing.

The second blade clamp may be removable in a tool-free manner.

According to an aspect, an example embodiment of an oscillating tool, includes: a housing; a motor in the housing; a clamp assembly operatively driven by the motor in an oscillating motion about an oscillating axis, the clamp assembly comprising a first blade clamp and a second blade clamp opposing the first blade clamp, the clamp assembly configured to selectively hold a power tool accessory between the first blade clamp and the second blade clamp; a clamp lever disposed at an underside of the housing and adjacent to the clamp assembly. The clamp lever is pivotable about a pivot axis.

The pivot axis may be rearward of the oscillating axis.

The pivot axis may be perpendicular to the oscillating axis.

The second blade clamp may be removable in a tool-free manner.

According to an aspect, an example embodiment of an oscillating tool, includes: a housing; a motor in the housing; a headbox at least partially in the housing; an output spindle at least partially in the headbox; a blade clamp shaft extending in an interior of the output spindle; a first blade clamp associated with the output spindle; a second blade clamp associated with the blade clamp shaft; and a yoke configured to move the second blade clamp away from the first blade clamp.

The power tool may further include a pusher spindle between the yoke and blade clamp shaft.

The power tool may further include a connector spindle between the pusher spindle and the blade clamp shaft, wherein motion of the yoke is transferred to the second blade clamp through the pusher spindle and the connector spindle.

The power tool may further include a clamp spring between a portion of the output spindle and a portion of the connector spindle.

The second blade clamp may be removable in a tool-free manner.

The power tool may further include a user actuatable clamp actuator configured to move the yoke.

The clamp actuator may further include a clamp lever.

The clamp actuator may be disposed adjacent to the blade clamp.

The yoke may have a generally upside-down U-shape.

The power tool may further include a yoke spring configured to bias the yoke.

The yoke may further extend along a first side of the headbox, a top of the headbox, and a second side of the headbox opposite the first side of the headbox.

According to an aspect, an example embodiment of an oscillating tool, includes: a housing; a motor in the housing; a blade clamp configured to selectively hold an output accessory, the blade clamp configured to driven by the motor and oscillate about an oscillating axis; a clamp actuator disposed at an underside of the housing and configured to operate the blade clamp; a yoke connected to the clamp actuator and extending to an upper end of a pusher.

The yoke may have a generally upside-down U-shape.

The power tool may further include a yoke spring configured to bias the yoke.

The yoke may further extend along a first side of a headbox, a top of the headbox, and a second side of the headbox opposite the first side of the headbox.

According to an aspect, an example embodiment of a power tool, includes: a housing; a motor in the housing; a clamp assembly operatively driven by the motor in an oscillating motion about an oscillating axis, the clamp assembly configured to selectively hold a power tool accessory; a clamp lever configured to operate the clamp assembly to move between a clamped position and an unclamped position; and a yoke operatively coupled to the clamp lever; wherein the yoke is biased by a spring; and wherein a spring cradle is disposed between the yoke and the spring.

A first side of the spring cradle may engage the spring.

A second side of the spring cradle may engage the yoke.

The spring cradle may include a groove.

The groove may be configured to accommodate a curved of the yoke.

The power tool may further include a headbox in the housing.

The spring may be supported on an upper end of the headbox.

The spring may be configured to bias an upper end of the yoke away from the headbox.

The spring may have a first end adjacent to the headbox.

The spring may have a second end adjacent to the spring cradle.

The first end of the spring may have a larger diameter than the second end of the spring.

The yoke may extend along the first side of the headbox and the second side of the headbox.

The power tool may further include a bearing in the headbox.

According to an aspect, an example embodiment of a power tool, includes: a housing; a motor in the housing; a clamp assembly operatively driven by the motor in an oscillating motion about an oscillating axis, the clamp assembly configured to selectively hold a power tool accessory; a clamp lever configured to operate the clamp assembly to move between a clamped position and an unclamped position; and a yoke operatively coupled to the clamp lever. The yoke may be biased by a spring. The spring may be a leaf spring.

The leaf spring may include a base body and a first leg extending from the base body.

The base body may be supported by the headbox.

The first leg may operatively engage the yoke.

The yoke may be forward of the base body.

The leaf spring may include a first engagement feature which engages the headbox.

The first engagement feature may be an opening.

The leaf spring includes a second engagement feature which engages the headbox.

The second engagement feature may be a groove.

The power tool may further include a second leg that operatively engages the yoke.

The yoke may extend along the first side of the headbox and the second side of the headbox.

According to an aspect, an example embodiment of a power tool, includes: a housing; a motor in the housing; a clamp assembly operatively driven by the motor in an oscillating motion about an oscillating axis, the clamp assembly configured to selectively hold a power tool accessory; a clamp lever movable between an actuated position and an unactuated position to move the clamp assembly between a clamped position and an unclamped position; and a torsion spring biasing the clamp lever to the unactuated position.

The power tool of may further include a headbox in the housing.

A first portion of the torsion spring may be braced against the headbox.

A second portion of the torsion spring may be braced against the clamp lever.

The headbox may include a projection.

The torsion spring may be secured at the projection.

A central portion of the torsion spring may be around the projection.

The headbox may include a first projection and a second projection.

A first side section of the torsion spring may be around the first projection.

A second side section of the torsion spring may be around the second projection.

The power tool may further include a central section between the first side section and the second side section.

According to an aspect, an example embodiment of a power tool, includes: a housing; a motor in the housing; a clamp assembly operatively driven by the motor in an oscillating motion about an oscillating axis, the clamp assembly configured to selectively hold a power tool accessory; a clamp lever movable between an actuated position and an unactuated position to move the clamp assembly between a clamped position and an unclamped position; and a first torsion spring and a second torsion spring, wherein the first torsion spring and the second torsion spring bias the clamp lever to the unactuated position.

According to an aspect, an example embodiment of a power tool, includes: a housing; a motor in the housing; a clamp assembly operatively driven by the motor in an oscillating motion about an oscillating axis, the clamp assembly configured to selectively hold a power tool accessory; a clamp lever movable between an actuated position and an unactuated position to move the clamp assembly between a clamped position and an unclamped position; and a torsion spring configured to bias the clamp lever to the unactuated position. The clamp lever may include a projection. The torsion spring may be attached to the clamp lever at the projection.

According to an aspect, an example embodiment of a power tool, includes: a housing; a motor in the housing; a clamp assembly operatively driven by the motor in an oscillating motion about an oscillating axis, the clamp assembly configured to selectively hold a power tool accessory; a clamp lever movable between an actuated position and an unactuated position to move the clamp assembly between a clamped position and an unclamped position; and a torsion spring configured to bias the clamp lever to the unactuated position. The clamp lever may include a first projection and a second projection opposite the first projection. The torsion spring may be attached to the clamp lever at the first projection and the second projection.

The torsion spring may include a first side section, a second side section, and a connection section between the first side section and the second side section.

The first side section may connect the torsion spring to the clamp lever at the first projection.

The second side section may connect the torsion spring to the clamp lever at the second projection.

According to an aspect, an example embodiment of a power tool, includes: a housing; a motor in the housing; a headbox in the housing adjacent to a forward end of the housing; a clamp assembly operatively driven by the motor in an oscillating motion about an oscillating axis, the clamp assembly configured to selectively hold a power tool accessory; a clamp lever movable between an actuated position and an unactuated position to move the clamp assembly between a clamped position and an unclamped position; and a torsion spring configured to bias the clamp lever to the unactuated position. The headbox may include a boss adjacent to the clamp lever. The torsion spring may be attached to the headbox at the box.

The torsion spring may include a central portion, a first leg, and a second leg.

The central portion of the torsion spring may engage the boss of the headbox.

The first leg may be biased against the clamp lever.

The second leg may be biased against the headbox.

The power tool may include at least one housing element configured to retain the central portion of the torsion spring on the headbox.

According to an aspect, an example embodiment of a power tool, includes: a housing; a motor in the housing; a headbox at least partially in the housing; an output spindle at least partially in the headbox; a blade clamp shaft extending in an interior of the output spindle; a first blade clamp associated with the output spindle; a second blade clamp associated with the blade clamp shaft; a yoke configured to move the second blade clamp away from the first blade clamp; and a user actuatable clamp actuator configured to move the yoke. The yoke may extend along a first side of the headbox, a top of the headbox, and a second side of the headbox opposite the first side of the headbox. The yoke may have a generally upside-down U-shape with a first end and a second end. The first end may have a first reduced diameter portion. The second end may have a second reduced diameter portion.

The power tool may include a first flat at the first end.

The power tool may include a second flat at the second end.

The power tool may include a first hole at the first end.

The power tool may include a second hole at the second end.

The power tool may include a first spring around the first reduced diameter portion and a second spring around the second reduced diameter portion.

The headbox may include a first stop abutting the first spring and a second stop abutting the second spring.

According to an aspect, an example embodiment of a power tool, includes: a housing; a motor in the housing; a clamp assembly operatively driven by the motor in an oscillating motion about an oscillating axis, the clamp assembly configured to selectively hold a power tool accessory; a clamp lever movable between an actuated position and an unactuated position to move the clamp assembly between a clamped position and an unclamped position; and an extension spring configured to bias the clamp lever to the unactuated position.

The power tool may further include an engagement hole in the clamp lever.

A first end of the extension spring may be attached to the clamp lever at the engagement hole.

The power tool may further include a headbox.

A second end of the extension spring may be attached to the headbox.

The headbox may include an engagement projection.

The second end of the extension spring may be attached to the headbox at the engagement projection.

The clamp lever may include a pivot.

The extension spring may be operably attached to the clamp lever at a first side of the pivot.

A grip portion of the clamp lever may be at a second side of the pivot.

The first side of the pivot may be at a forward side.

The second side of the pivot may be at a rearward side.

According to an aspect, an example embodiment of an oscillating tool includes: a housing; a motor in the housing; a first blade clamp; a blade clamp shaft and a second blade clamp on the blade clamp shaft. The blade clamp shaft may include a latching portion configured to engage a seat. The oscillating tool may further include a blade clamp spring configured to bias the latching portion into engagement with the seat

The oscillating tool may further include a spring keeper between the blade clamp spring and the latching portion. The spring keeper may be configured to transfer the biasing force of the blade clamp spring to the blade clamp shaft.

The spring keeper may include a first portion of a first diameter and a second portion of a second diameter.

The second portion may be relatively closer to the blade clamp shaft than the first portion is to the blade clamp shaft.

The second diameter may be greater than the first diameter.

The blade clamp shaft and the second blade clamp may comprise a single integral part.

The spring keeper may include a substantially cylindrical cross-section.

The spring keeper may include a first portion of a first diameter and a second portion of a second diameter. The second portion may be relatively closer to the blade clamp shaft than the first portion is to the blade clamp shaft. The second diameter may be greater than the first diameter.

A portion of the blade clamp spring may surround the first portion of the spring keeper.

The blade clamp spring may abut the second portion of the spring keeper.

The first portion of the spring keeper may have a generally circular outer circumferential surface.

The second portion of the spring keeper may have a generally circular outer circumferential surface.

According to an aspect, an example embodiment of an oscillating tool includes: a housing; a motor in the housing; a clamp assembly operatively driven by the motor in an oscillating motion about an oscillating axis, the clamp assembly comprising a first blade clamp and a second blade clamp opposing the first blade clamp, the clamp assembly configured to selectively hold a power tool accessory between the first blade clamp and the second blade clamp. The second blade clamp may be on a blade clamp shaft. The blade clamp shaft may be selectively removable and may comprise a latching portion. The oscillating tool may further include a seat, the latching portion may be configured to engage the seat to secure the blade clamp shaft in the oscillating tool. The oscillating tool may further include a blade clamp spring configured to bias the latching portion into the seat. The oscillating tool may further include a spring keeper operably between the blade clamp spring and the latching portion.

The spring keeper may have a substantially cylindrical cross-section.

The spring keeper may include a first portion of a first diameter and a second portion of a second diameter. The second portion may be relatively closer to the blade clamp shaft than the first portion is to the blade clamp shaft. The second diameter may be greater than the first diameter.

A portion of the blade clamp spring may surround the first portion of the spring keeper. The blade clamp spring may abut the second portion of the spring keeper.

The first portion of the spring keeper may have a generally circular outer circumferential surface.

The second portion of the spring keeper may have a generally circular outer circumferential surface.

A force of the blade clamp spring may be configured to be overcome by a user pushing against the force of the blade clamp spring.

According to an aspect, an example embodiment of an oscillating tool includes: a housing; a motor in the housing; a first blade clamp; a blade clamp shaft and a second blade clamp on the blade clamp shaft. The blade clamp shaft may include a latching portion configured to engage a seat. The oscillating tool may further include a blade clamp spring configured to bias the latching portion into engagement with the seat and a spring keeper between the blade clamp spring and the latching portion. The spring keeper may be configured to transfer the biasing force of the blade clamp spring to the blade clamp shaft. A force of the blade clamp spring may be configured to be overcome by a user pushing against the force of the blade clamp spring.

Various features of the different aspects and embodiments may be combined or substituted with one another as appropriate.

These and other aspects of various embodiments, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

Example embodiments of the present application are described with reference to and in conjunction with the accompanying drawings, in which:

FIG. 1 is side view of an oscillating tool according to an exemplary embodiment;

FIG. 2 is side view showing internal parts of an exemplary embodiment;

FIG. 3 is a side view of a front portion of an exemplary embodiment;

FIG. 4 is a cross-sectional side view of a front portion of an exemplary embodiment;

FIG. 5 is a perspective view of a front portion of an exemplary embodiment;

FIG. 6 is a perspective view of a spring of an exemplary embodiment;

FIG. 7 is a perspective view of a yoke of an exemplary embodiment;

FIG. 8 is a perspective view of a clamp lever of an exemplary embodiment;

FIG. 9 is a perspective view of a front portion of an exemplary embodiment;

FIG. 10 is a perspective view of a clamp lever assembly of an exemplary embodiment;

FIG. 11 is a side view of an internal front portion of an exemplary embodiment;

FIG. 12 is a side view of an internal front portion of an exemplary embodiment;

FIG. 13 is a side view of an internal front portion of an exemplary embodiment;

FIG. 14 is a side view of an internal front portion of an exemplary embodiment;

FIG. 15 is a side cross-sectional explanatory view of a clamping mechanism assembly according to an exemplary embodiment;

FIG. 16 is a side cross-sectional explanatory view of a clamping mechanism assembly according to an exemplary embodiment;

FIG. 17 is a perspective view of a clamping mechanism assembly according to an exemplary embodiment;

FIG. 18 is a side cross-sectional view of a clamping mechanism assembly according to an exemplary embodiment;

FIG. 19 is a perspective view of an example embodiment of an oscillating tool accessory;

FIG. 19 is a perspective view of an example embodiment of an oscillating tool accessory;

FIG. 19 is a perspective view of an example embodiment of an oscillating tool accessory;

FIG. 20 is a perspective view of a spring cradle and assembly according to an example embodiment;

FIG. 21 is a side view of a spring cradle and assembly according to an example embodiment;

FIG. 22 is an illustration of a spring cradle and spring according to an example embodiment;

FIG. 23 is a perspective view of a leaf spring and assembly according to an example embodiment;

FIG. 24 is a perspective view of a leaf spring and assembly according to an example embodiment;

FIG. 25 is a perspective view of a leaf spring according to an example embodiment;

FIG. 26 is a perspective view of a pair of torsion springs and assembly according to an example embodiment;

FIG. 27 is a perspective view of a single torsion spring and assembly according to an example embodiment;

FIG. 28 is a perspective view of a single torsion spring and assembly according to an example embodiment;

FIG. 29A is a perspective view of clamp lever and torsion spring assembly according to an example embodiment;

FIG. 29B is a perspective view a torsion spring according to an example embodiment;

FIG. 30 is a perspective side view of clamp lever and torsion spring assembly according to an example embodiment;

FIG. 31 is a perspective view of a compression spring and assembly according to an example embodiment;

FIG. 32 is a side view of a compression spring and assembly according to an example embodiment;

FIG. 33 is a perspective view of a portion of a yoke according to an example embodiment;

FIG. 34 is a perspective view of a portion of a yoke and assembly according to an example embodiment;

FIG. 35 is a perspective view of a portion of an extension spring and assembly according to an example embodiment;

FIG. 36 is a cross-sectional view of an exemplary embodiment including a clamp spring;

FIG. 37 is another cross-sectional view of an exemplary embodiment including a clamp spring; and

FIG. 38 is another cross-sectional view of an exemplary embodiment including a clamp spring.

### DETAILED DESCRIPTION OF EXEMPLARY EMBODIMENTS

The drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

All closed-ended (e.g., between A and B) and open-ended (greater than C) ranges of values disclosed herein explicitly include all ranges that fall within or nest within such ranges. For example, a disclosed range of 1-10 is understood as also disclosing, among other ranged, 2-10, 1-9, 3-9, etc.

As used herein, the terminology “at least one of A, B and C” and “at least one of A, B and C” each mean any one of A, B or C or any combination of A, B and C. For example, at least one of A, B and C may include only A, only B, only C, A and B, A and C, B and C, or A, B and C.

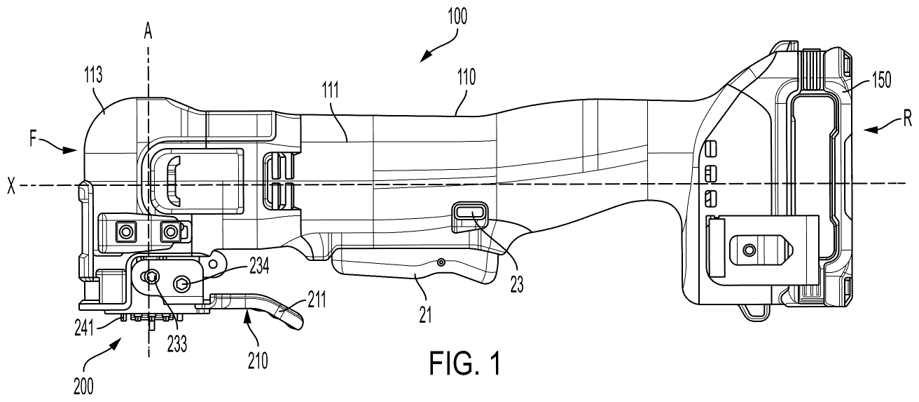

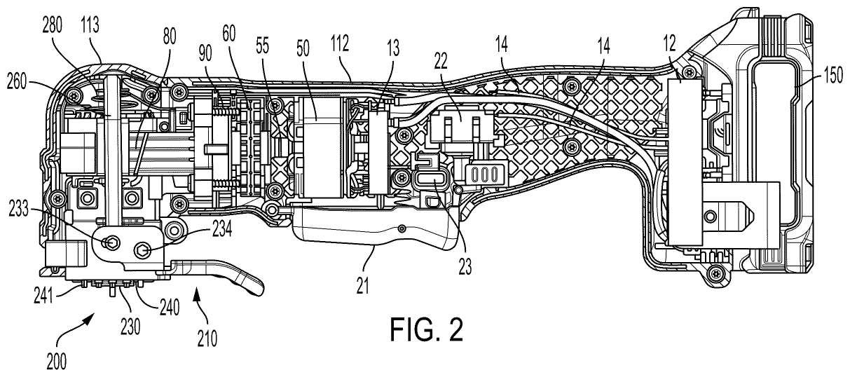

FIGS. 1 and 2 illustrate an exemplary embodiment of an oscillating tool 100. FIG. 1 is a side view of the example embodiment of the oscillating tool 100 and FIG. 2 is another side view of the example embodiment of the oscillating tool 100 with a housing part removed for illustrating internals of the tool 100. An oscillating power tool drives an accessory in an oscillating manner about axis A.

As shown in FIG. 1, the oscillating tool 100 includes a housing 110. A trigger 21 is on the housing for turning the oscillating tool 100 on and off. In the example embodiment, the trigger 21 is disposed at an underside of the housing. At a rear of the tool adjacent to the battery pack 150 there is a battery foot. The battery foot includes a battery pack receptacle configured to receive a power tool battery pack 150. A belt clip may be attached to the foot portion. The power tool battery pack 150 provides power for the oscillating tool 100 through the battery pack receptacle. The power tool battery pack may be of the type shown in, for example, U.S. Pat. Nos. 7,598,705; 7,661,486; or U.S. Patent Application Publication No. 2018/0331335. U.S. Pat. Nos. 7,598,705; 7,661,486; and U.S. Patent Application Publication No. 2018/0331335 are hereby incorporated by reference.

The housing 110 includes a main body housing which includes a first housing shell 111 and a second housing shell 112. The housing 110 also includes a forward or headbox housing 113 at a front end of the oscillating tool 100. The first housing shell 111 is removed in FIG. 2 for purposes of illustrating internal components of the oscillating tool 100.

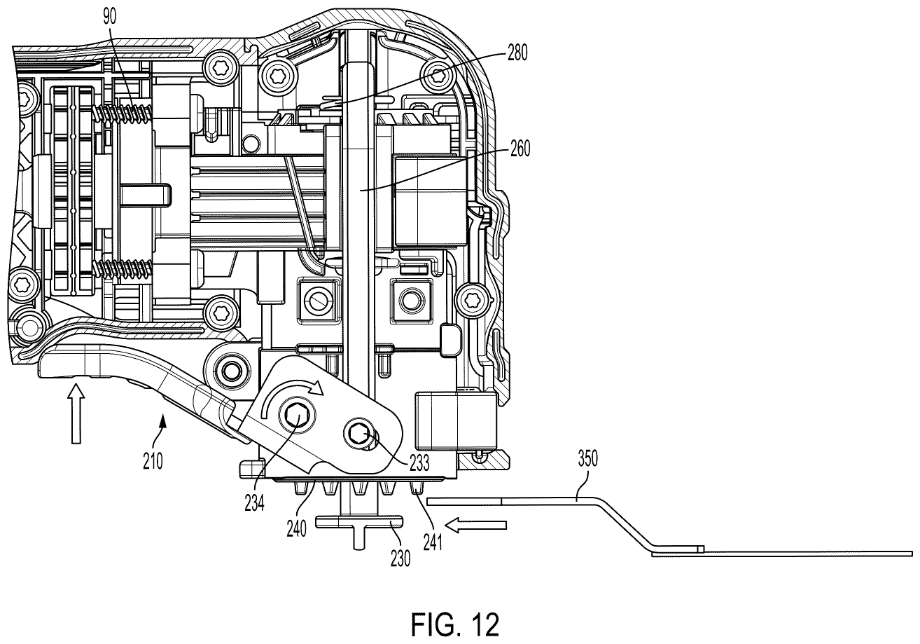

As shown in FIGS. 1 and 2, the oscillating tool 100 includes a blade clamp assembly 200 configured to securely hold an oscillating tool accessory such as an oscillating tool cutting blade 350 (see, e.g., FIGS. 12, 13 and 19). A variety of oscillating tool accessories may be securely held by the blade clamp assembly 200. For example, the blade clamp assembly 200 may also securely hold a sanding attachment, a grout removing blade, a scraping blade or other oscillating tool accessory and these various accessories may be alternatively held securely by the blade clamp assembly 200 for use.

As shown in FIGS. 1 and 2, the exemplary embodiment of the oscillating tool has a body with a longitudinal axis X. The blade clamp assembly 200 is at a front F of the oscillating tool 100 and the foot is at a rear R of the oscillating tool 100.

FIG. 2 is a side view of the exemplary embodiment of the oscillating tool 100 with housing part 111 removed for illustrative purposes. The oscillating tool 100 includes a battery pack receptacle 12 at the foot of the oscillating tool 100. The battery pack receptacle 12 may include electrical connectors configured to provide an electrical connection to the battery pack 150. The battery pack receptacle 12 may also include one or more rails configured to guide the battery pack 150 into engagement with the electrical connectors. The battery pack receptacle 12 may include one or more vibration dampening members.

As shown in FIG. 2, the oscillating tool 100 may further include a module 13. The module 13 may be electrically connected to the battery pack receptacle 12 by, for example, wires. The wires 14 may provide a path for electric power from the battery pack 150. Data information may also be carried by the wires 14. The module 13 may include one or more printed circuit board and various components on the one or more printed circuit boards. For example, the module 13 may include a controller and the controller may include one or more programmable micro-processor or other programmable or non-programmable control integrated circuit. The components included in the module 13 may include one or more sensors. For example, the module 13 may include one or more current sensor, voltage sensor or temperature sensor. The controller included in the module 13 may include motor controls for controlling operation of the motor 50. The controller included in the module 13 may include one or more controls for the switch 22 or the battery 150. The module 13 of an example embodiment may be electrically connected to a switch 22 and the motor 50 by wires 14. The wires 14 may allow electrical power and/or data connections between the various components.

The oscillating tool 100 includes a user-operable trigger switch 20. The trigger switch 20 includes a rotatable trigger 21 and a switch module 22. In the example embodiment the trigger 21 may be a separate component that actuates a separate switch 22. In other embodiments, the trigger switch 20 may be one integrated part. The trigger switch 20 may provide variable speed control of the motor 50. In other embodiments, the trigger switch 20 may be configured to provide on and off control of the motor and a separate speed control may be provided. The separate speed control may include, for example, a user-operable dial that allows a user to set a speed of motor 50 and therefore a speed of oscillation for the oscillating tool 100. The example embodiment may include a forward/reverse bar 23. The forward/reverse bar 23 may be set in a forward potion for forward operation; a reverse position for reverse operation or a locked-off position that prevents the trigger switch 20 from being activated. The locked-off position may include the forward/reverse bar 23 being located at a central position. The forward/reverse bar 23 may also be configured to allow the trigger switch 20 to be in a locked-on position in which the trigger switch 20 is secured in an activated position without the need for a user to continuously depress the trigger 21.

The motor 50 of the exemplary embodiment is a DC brushless motor. In some embodiments, the motor 50 may include positional sensors, such as Hall sensors, to assist with control of the brushless motor 50. In other embodiments, rotational positional information relating to the motor 50 rotor may be calculator or detected without any positional sensors, (what may be known in the art as sensorless brushless motor control). In other embodiments the motor may be a brushed motor, a universal motor or another type of motor.

The motor 50 of the example embodiment drives an output shaft 55. A double-sided blade fan 60 is disposed on the shaft 55 and rotates along with the shaft 55. The fan 60 is adjacent to a bearing seat 90. The bearing seat 90 is secured to a headbox 80. An eccentric 410 and an oscillating fork 400 are disposed in the headbox 80 and convert rotational movement of the shaft 55 into oscillating movement for the clamp assembly 200. The oscillating fork 400 is engaged with an output spindle 250. One or more bearings may also be housed in the headbox 80. Additionally, at least a portion of an output spindle may be housed in the head box 80. In operation, the oscillating fork is connected to an output spindle and the output spindle is engaged with the clamp assembly 200. Rotational movement of the shaft 55 is converted into oscillating movement such that the output spindle 250 oscillates back and forth and the clamp assembly 200 oscillates back and forth along with the output spindle 250. At least one bearing for the output spindle may be housed in the headbox 80. The headbox 80 may be made of metal. The metal may include, for example, one or more of aluminum and steel.

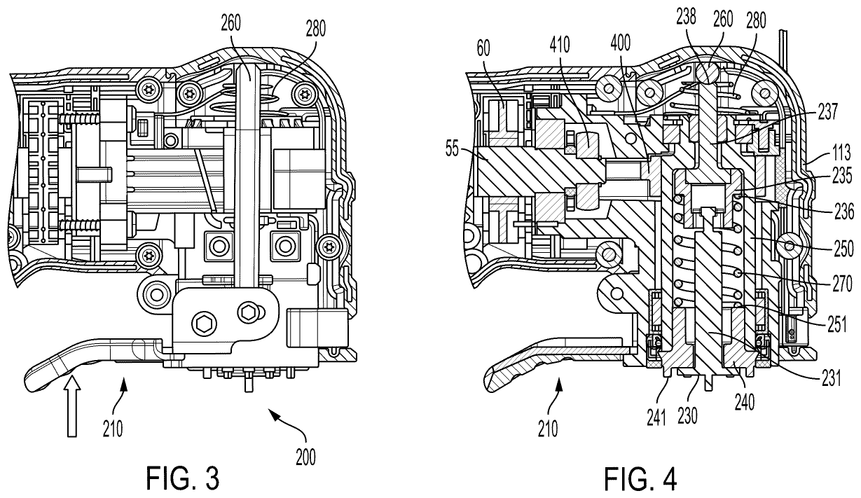

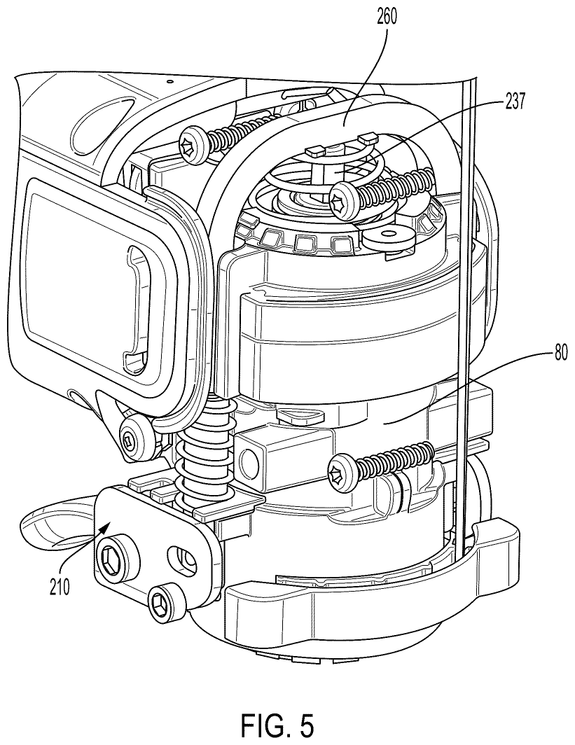

FIGS. 3-8, 17 and 18 illustrate features of the clamp assembly 200 in more detail. As shown, the oscillating tool 10 includes a clamp lever 210 disposed at an underside of the housing 100 adjacent to the bottom blade clamp 230 and the top blade clamp 240. The clamp lever 210 is shown by itself in FIG. 8. The clamp lever 210 may be made of stamped metal, such as stamped steel. A grip portion 211 may be covered by a plastic material. The clamp lever 210 includes a first set of holes 212 and a second set of holes 213. The first set of holes 212 and the second set of holes 213 each receive respective shoulder screws. As described in furth detail later, the clamp lever 210 is rotatable about an axis defined by the first set of holes 212 and the second set of holes 213 interact with a yoke.

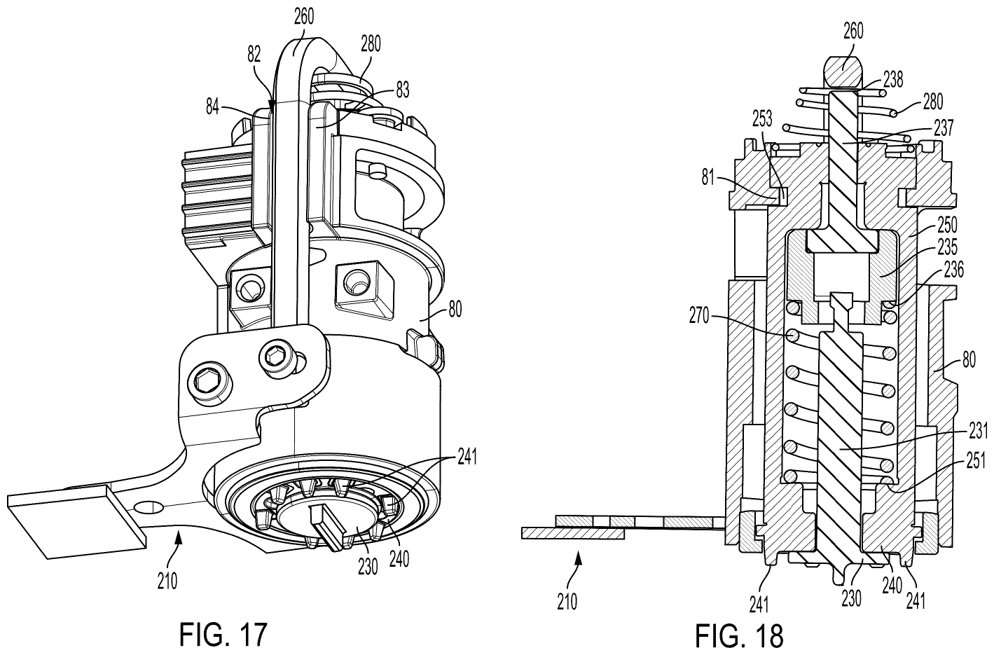

FIG. 3 is a side view of a forward portion of the oscillating tool 10 with a housing part 112 removed. FIG. 4 is a cross-sectional side view of a forward portion of the oscillating tool 10. FIGS. 17 and 18 illustrate the clamping operational mechanism of the oscillating tool 10. FIG. 17 is a perspective view of the clamping operational mechanism and FIG. 18 is a side cross-sectional view.

As shown in FIGS. 3, 4, 17 and 18, for example, the clamping operational mechanism includes a bottom blade clamp 230 and a top blade clamp 240. The top blade clamp 240 includes a plurality of projections 241 configured to engage holes of an oscillating tool accessory. The top blade clamp 240 is formed at the lower end of output spindle 250. In the example embodiment, the top blade clamp 240 is integrally formed as one piece with the output spindle 250. In other example embodiments, the top blade clamp 240 may be a separate piece joined with the output spindle 250.

The bottom blade clamp 230 is formed at the bottom of blade clamp shaft 231. In the example embodiment, the bottom blade clamp 230 is integrally formed as one piece with the blade clamp shaft 231. The bottom blade clamp 230 is movable in an up and down direction relative to the top blade clamp 240 and the headbox 80. The top blade clamp 240 is fixed with respect to the headbox 80.

As shown in, for example, FIGS. 4 and 18, the blade clamp shaft 231 is attached to an inner pusher spindle 237 by an inner connector spindle 235. A top end 238 of the inner pusher spindle 237 abuts yoke 260. Inner clamp spring 270 is disposed in the output spindle 250. As shown, the inner clamp spring 270 surrounds the blade clamp shaft 231. A lower end of the inner clamp spring 270 abuts a ledge 251 of the output spindle 250. An upper end of the inner clamp spring 270 abuts a ledge 236 of the inner connector spindle 235. The inner clamp spring 270 biases the inner connector spindle 235 upwardly relative to the output spindle 250 and the top blade clamp 240 on the output spindle 250. Since the blade clamp shaft 231 with bottom blade clamp 230 are attached to the inner connector spindle 235, the blade clamp shaft 231 and bottom blade clamp 230 are biased upwardly as well. The blade clamp shaft 231 of the example embodiment is rotationally fixed with the output spindle 250 so that it rotates along with the output spindle 250 causing the bottom blade 230 and the top blade 240 of the clamp assembly 200 to oscillate along with oscillation of the output spindle 250. In embodiments, the inner connector spindle 235 may be rotationally fixed to the output spindle 250 and oscillate with the output spindle 250. In embodiments, the inner pusher spindle 237 may be rotationally fixed to the output spindle 250 and oscillate with the output spindle 250. The bottom blade clamp 230 upward bias biases the bottom blade clamp 230 towards the top blade clamp 240 and accordingly provides a clamping force to an oscillating tool accessory disposed between the bottom blade clamp 230 and the top blade clamp 240. In the example embodiment, the blade clamp shaft 231 is removably coupled to the inner connector spindle 235. A user may rotate and remove the blade clamp shaft 231.

The inner pusher spindle 237 is also biased upwardly by the inner clamp spring 270 by virtue of the inner pusher spindle 237 being engaged with the inner connector spindle 235. In the example embodiment, the inner pusher spindle 237 is a separate part engaged with the inner connector spindle 235. The inner pusher spindle 237 may or may not be secured to the inner connector spindle 235 by an adhesive or other means. In other embodiment, the inner pusher spindle 237 may be formed as a single integral part with the inner connector spindle 235.

As shown in FIGS. 3, 4, 17 and 18, for example, the yoke 260 is biased upwardly by a yoke lifter spring 280. The yoke lifter spring 280 biases the yoke 260 upwardly. The yoke 260 is also biased upwardly by virtue of the inner pusher spindle 237, which is itself biased upwardly as discussed above.

As shown in FIG. 18, the output spindle 250 is axially fixed relative to the headbox 80. In the example embodiment, the output spindle includes a recess 253 and the headbox 80 includes a projection 81 which engages the recess 253. Engagement of the output spindle 250 with the headbox 80 prevents upward and downward movement of the output spindle 250. The output spindle 150 is rotatable relative to the headbox 80 in order to allow oscillating motion.

As shown in FIGS. 3 and 17, the headbox 80 includes a guide groove 82 on either side of the headbox 80. The guide groove 82 is configured to support and guide the yoke 260. The forward guide 83 and a rearward guide 84 are on either side of the guide groove 82. FIGS. 3 and 17 illustrate a guide groove 82, forward guide 83 and rearward guide 84 on one side of the headbox 80 and an identical guide groove 83, forward guide 83 and rearward guide 84 may be on the opposite side.

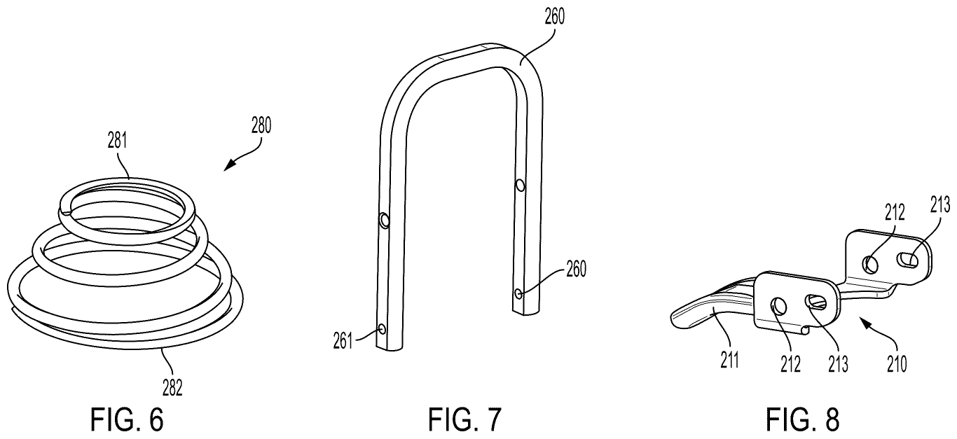

FIG. 6 illustrates yoke lifter spring 280. As shown, yoke lifter spring 280 may have a smaller diameter at a top end 281 and a larger diameter at a bottom end 282.

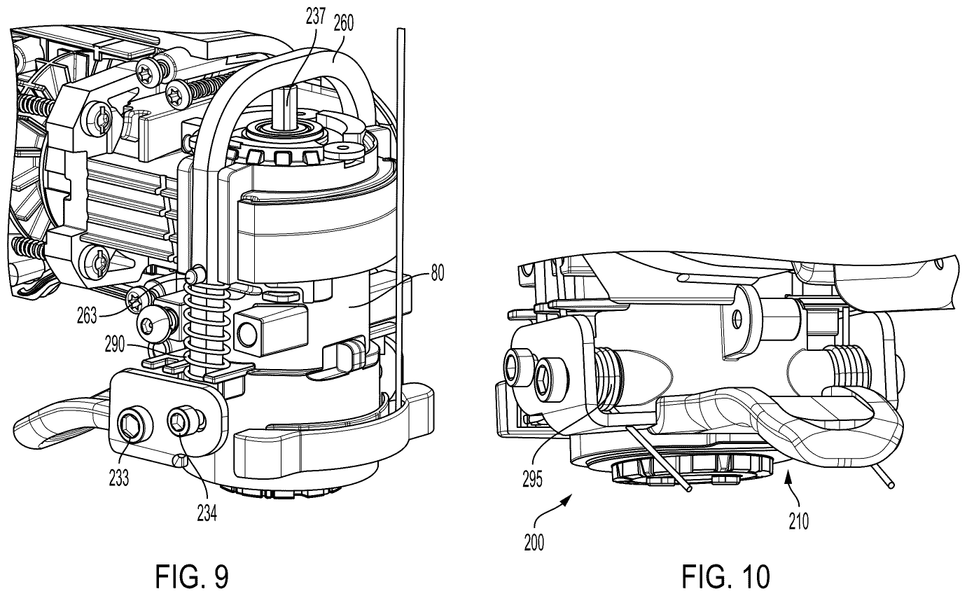

FIG. 7 illustrates the yoke 260. As shown, the yoke 260 has an upside down U-shape. The yoke 260 includes a pair of lever connection holes 261. The lever connection holes 261 align with the second set of holes 213 on the clamp lever 210. Shoulder screws 233 project through the connection holes 261 and second set of holes 213 to engage the clamp lever 210 with the yoke 260. The yoke 260 of the example embodiment may also include another set of holes 262 configured to retain spring engagement pins 263 shown in FIG. 9.

FIGS. 9 and 10 illustrate example embodiments of alternative or additional ways of biasing. FIG. 9 is a perspective view of a front portion of the oscillating tool 10. FIG. 9 illustrates spring 290. Spring 290 is disposed between the engagement pin 263 and shoulder screw 233 to bias the clamp lever 210 to the clamped or non-actuated position, as shown in FIG. 9. FIG. 10 shows a biasing spring 295 to bias the clamp lever 210 to the clamped or non-actuated position.

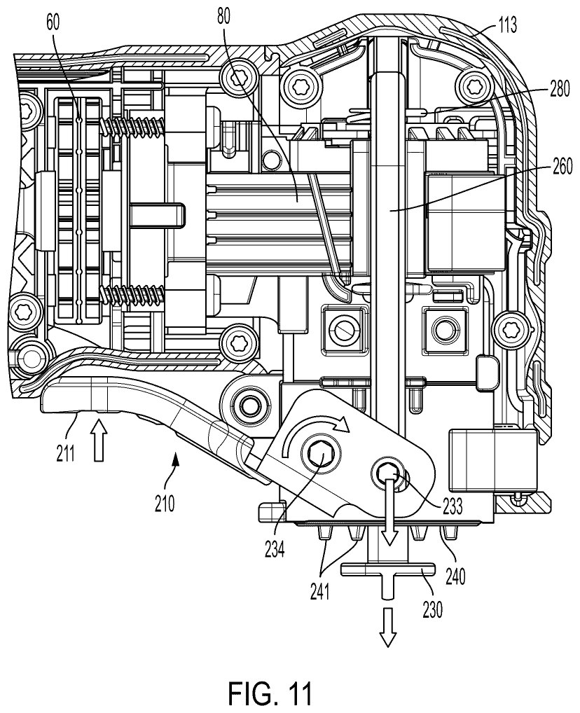

FIGS. 3 and 11-16 illustrate operation of the blade clamp assembly 200. FIG. 3 illustrates the blade clamp lever 210 in a rest or secured position in which the blade clamp lever 210 is not yet moved under force by a user. As shown in FIG. 3, a user may press upwardly on the blade clamp lever 210 as indicated by the arrow. As shown in FIG. 11, as the user pulls upwardly on the grip portion 211 of the blade clamp lever 210, the grip portion 211 of the blade clamp 210 may move upwardly towards the housing 110 of the oscillating tool 10. The blade clamp 210 rotates about a pivot point defined by shoulder screws 234 which extend through the first holes 212 in the blade clamp 210 and into holes in the headbox 80. The holes in the headbox 80 may be threaded so that the shoulder screws 234 can be screwed into the headbox 80.

As the blade clamp 210 rotates about the shoulder screw 234, the yoke shoulder screw 233 moves downwardly. The yoke shoulder screw 233 is engaged with the yoke 260. Accordingly, the yoke 260 also moves downwardly. As shown in FIG. 11, when the clamp lever 210 is pulled into an actuated position, a top end of the yoke 260 is farther away from the top of the housing 110 as compared to the position shown in FIGS. 3 and 4 in which the clamp lever 210 is not pulled by a user into an actuated position. As the yoke 260 is pulled down, it presses downwardly against the top end 238 of the inner pusher spindle 237. The inner pusher spindle 237 pressed down on the inner connector spindle 235. The inner connector spindle 235 presses down against the blade clamp shaft 231 which moves the bottom blade clamp 230 downward away from the top blade clamp 240, as shown in FIG. 11. As the yoke 260 is moved downwardly, the yoke lifter spring 280 and the inner clamp spring 270 are both compressed.

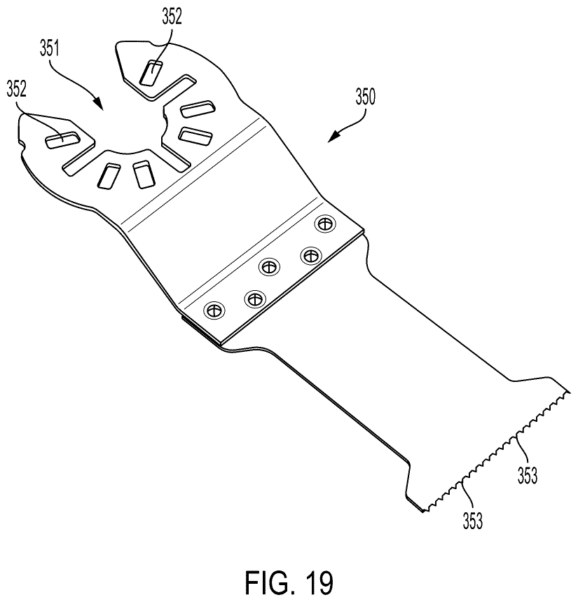

As shown in, for example, FIG. 12, when the blade clamp lever 210 is actuated and the bottom blade clamp 230 is moved away from the top blade clamp 240, there is a space created between the bottom blade clamp 230 and the top blade clamp 240. An oscillating tool accessory 350 may then be inserted in between the bottom blade clamp 230 and the top blade clamp 240. FIG. 12 illustrates the oscillating tool accessory 350 in a position of being inserted between the bottom blade clamp 230 and the top blade clamp 240. As shown in FIG. 19, the oscillating tool accessory 350 may be an open-ended accessory 350 having an open-ended aperture 351 allowing the oscillating tool accessory 350 to be inserted around the blade clamp shaft 231 without removal of the blade clamp shaft 231 and bottom blade clamp 230. The oscillating tool accessory 350 may include a variety of holes 352 configured to be engaged by the projections 241. A working end of the oscillating tool accessory 350 may include teeth 353 for performing work such as cutting. Various examples of open-ended accessories are shown in, for example, US Design U.S. Pat. No. 814,900; and U.S. Patent Application Publication Nos. 2022/0234124; 2022/0184721; 2021/0229198; and 2019/0022816. US Design U.S. Pat. No. 814,900; and U.S. Patent Application Publication Nos. 2022/0234124; 2022/0184721; 2021/0229198; and 2019/0022816 are each incorporated herein by reference in their entireties.

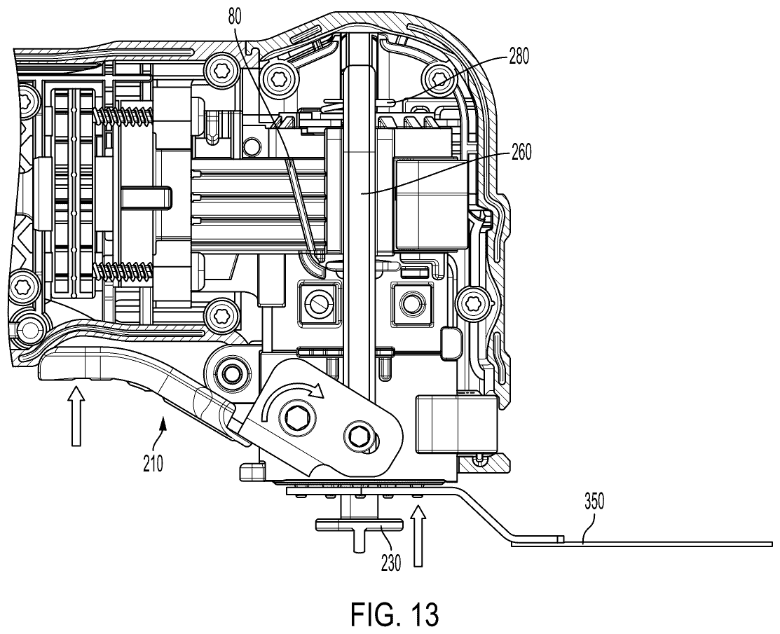

As shown in FIG. 13, the oscillating tool accessory 350 may be moved upwardly towards the top blade clamp 240 so that holes or apertures 352 in the accessory 350 engage protrusions 241 in the top blade clamp 240. The top blade clamp 240 may include one or more magnets for attracting and holding the oscillating tool accessory 350 at the top blade clamp 240. The magnets may have, for example, a circular cross-section, a rectangular cross-section, or an oblong cross-section. There may be a single magnet, two or more magnets, three or more magnets, or four or more magnets. The magnets may each have the same cross-sectional shape and the same or similar size, or magnets may have different cross-sectional shapes or sizes.

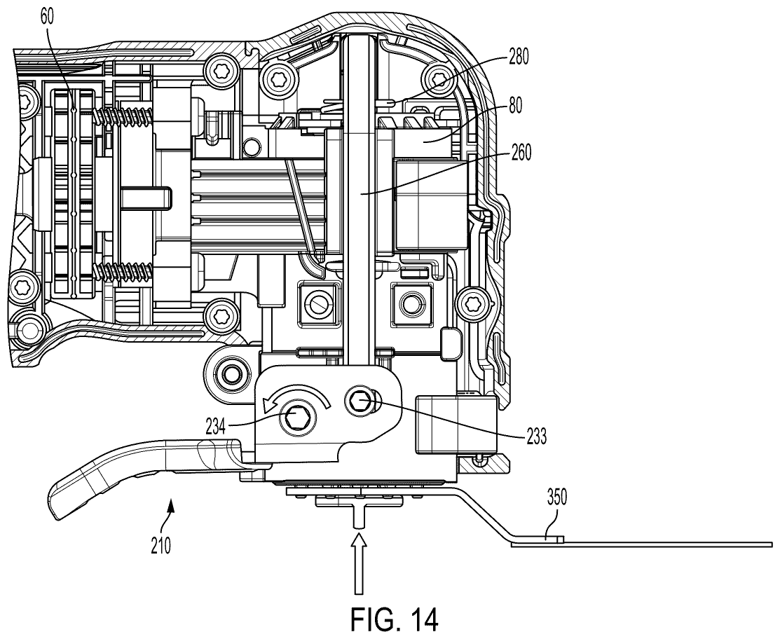

As shown in FIG. 14, once the oscillating tool accessory 350 is located in place between the top blade clamp 240 and the bottom blade clamp 230, the user may release the blade clamp lever 210 and the blade clamp lever 210 will return to its rest position due to the biasing force of the yoke lifter spring 280 and the inner clamp spring 270. As the yoke 260 moves upward, the inner pusher spindle 237, the inner connector spindle 235 and the blade clamp shaft 231 also move upwardly. Accordingly, the bottom blade clamp 230 moves upwardly into a clamping position of clamping the accessory 350 between the bottom blade clamp 230 and the top blade clamp 240. Due to the biasing force of the inner clamp spring 270 and the yoke lifter spring 280, the bottom blade clamp 230 clamps the accessory 350 against the top blade clamp 240 with a clamping force. The clamping force allows the accessory 350 to be held firmly as it is driven in an oscillating motion to perform work. In some example embodiments, the oscillating tool 10 may have only one of the springs 270 and 280. In some example embodiments, there may be springs other than the springs 270 and 280 to provide a biasing force to one of more of the parts such as the clamp lever 210 or the bottom blade clamp 230.

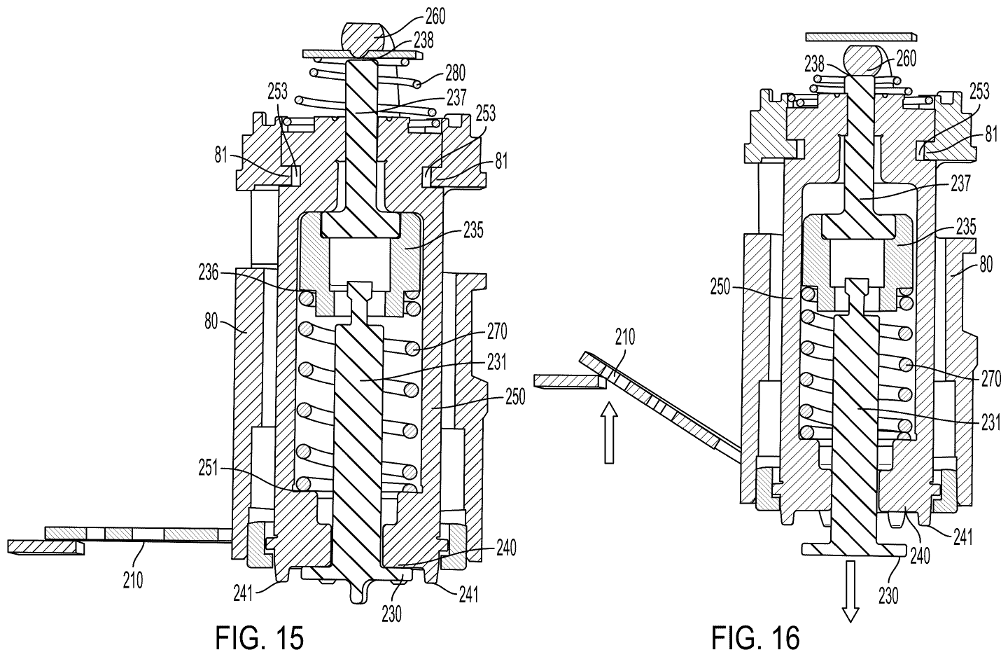

FIGS. 15 and 16 are cross-sectional schematic views illustrating operation of the blade clamp 200. As shown in FIG. 15, when no force is applied to the lever 210, the springs 270 and 280 bias the lever 210 to the position shown in FIG. 15 and the bottom blade clamp 230 towards the top blade clamp 240 to the clamping position shown in FIG. 15. In FIG. 16, the clamp lever 210 is pulled upwardly to an actuated position such that the bottom blade clamp 230 is spaced from the top blade clamp 240 and the springs 270 and 280 are compressed. In the actuated or open position of FIG. 16, the bottom blade clamp 230 may be rotated and removed from the tool 10. In particular, the bottom blade clamp 230 may be removed from the inner connector spindle 235, pulled out form inside the output spindle 250 and separated from the rest of the tool 10. A closed ended accessory that does not include an open-ended aperture may then be placed onto the top blade clamp 240. The blade clamp shaft 231 may then be reinserted into the tool until it reaches the inner connector spindle 235 and the blade clamp shaft 231 may then be rotated to reconnect with the inner connector spindle 235. In this manner, the blade clamp 200 may also accept a closed ended accessory by removal and reinsertion of the blade clamp shaft 231 and bottom blade clamp 230.

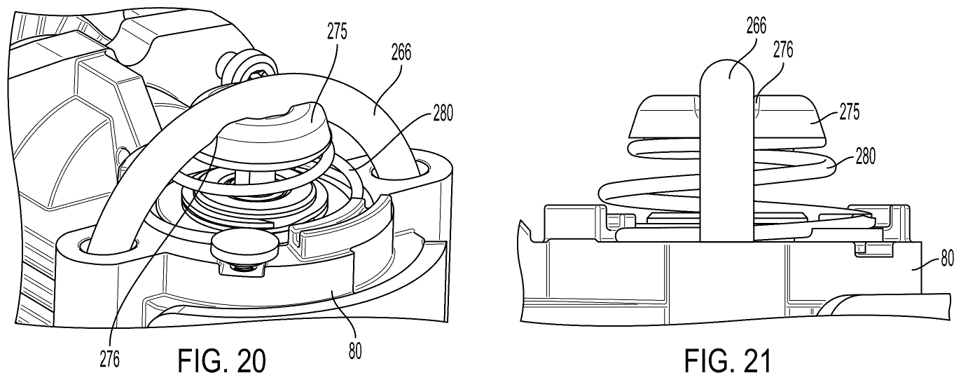

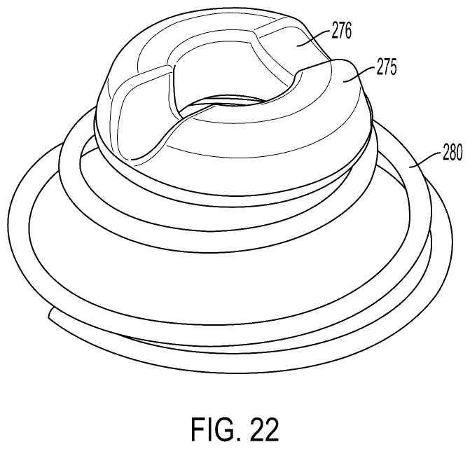

FIGS. 20-22 illustrate an exemplary embodiment including a spring cradle feature. In particular, in the example embodiment of FIGS. 20-22, a spring cradle 275 interacts with the spring 280 on one side and a yoke 266 on the other side. The yoke 266 is the same as the yoke 260, except that the yoke 266 has a slightly different cross-section. In particular, the yoke 266 has a generally circular cross section while the yoke 266 has flat sides as shown in, for example, FIGS. 3 and 4. In some embodiments, the yoke 260 may be used in place of yoke 266 and vice-versa.

As shown in FIGS. 20-22, the spring cradle 275 includes a groove 276. The groove 276 is configured to engage the yoke 266. Additionally, a bottom of the spring cradle 275 engages the spring 280. In the example embodiment, a diameter of the bottom of the spring cradle 275 may be roughly the same as a diameter of the top of the spring 280. In other embodiments, the diameter of the bottom of the spring cradle 275 may be equal to or greater than the diameter of the top of the spring 280.

The spring cradle 275 may be configured for reliable engagement with the yoke 266 and/or the spring 280. In this manner, the spring cradle may assist in transferring forces between the spring 280 and the yoke 266. For example, a biasing force of the spring 280 may be transferred through the spring cradle 275 to bias the yoke 266 upwardly. The spring cradle 275 may provide improved fit between the parts, more reliable engagement and force transfer, and may help with assembly. The spring cradle 275 may be made of a non-metallic material and may help to limit noise that could be caused by direct interaction between the spring 280 and yoke 266. The non-metallic material may be at least one of rubber or plastic.

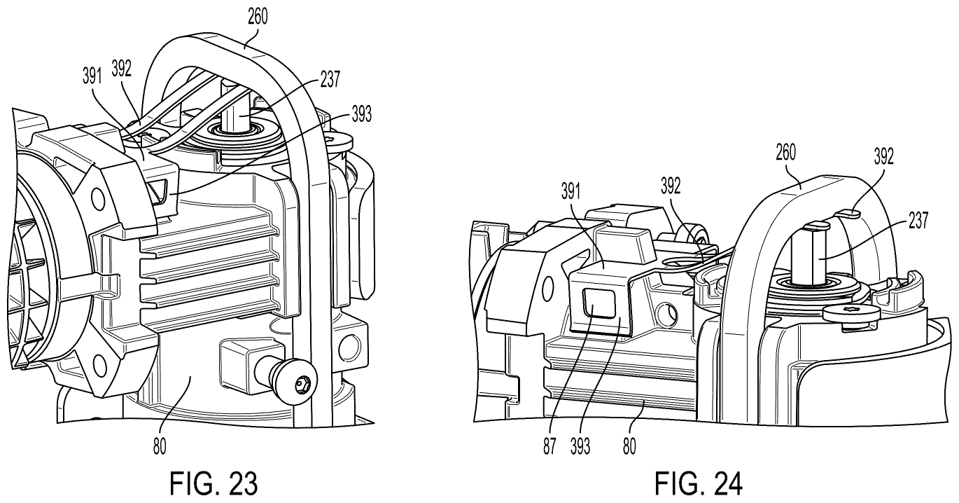

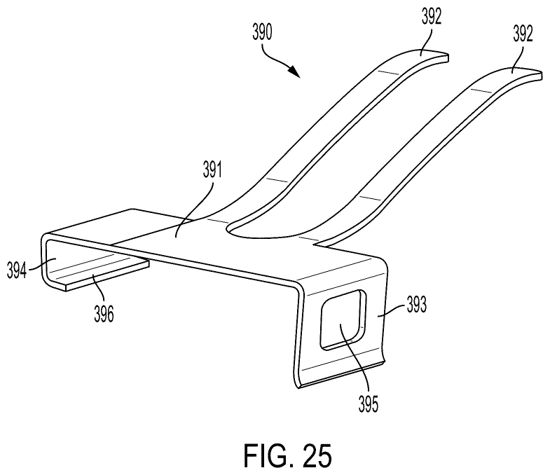

FIGS. 23-25 illustrate another example embodiment including a leaf spring 390 biasing the yoke 260. The leaf spring 390 serves a similar function as the conical spring 280 and may be used instead of or in addition to the conical spring 280 in various example embodiments. FIG. 25 illustrates the leaf spring 390 alone. FIGS. 23 and 24 illustrate a forward end of an oscillating tool with the leaf spring 390 biasing yoke 260.

As shown in FIG. 25, the leaf spring 390 includes a base body 391. A pair of arms 392 extend from the base body 391. In the example embodiment, there are two arms 392. In other embodiments, there may be a one or more arms, two or more arms or three or more arms. The leaf spring 390 also includes a first engagement side 393 and a second engagement side 394. The first side engagement 393 includes a hole 395 configured to engage with a projection on the headbox 80. The second side engagement 394 includes a slot 396 configured to engage with a rail on the headbox 80. In other example embodiments, both of the first side engagement 393 and second side engagement 394 may include the same type of engagement feature. For example, in an example embodiment, the first side engagement and the second side engagement may both include holes or both include slots and the headbox may include corresponding projections or rails on each side.

As shown in FIGS. 23 and 24, the leaf spring 390 is secured to the headbox 80. As shown in FIG. 24, the headbox 80 may include a projection 87 that engages the opening 395 in the first side engagement 393. The headbox may also include a rail as mentioned above. The two arms 392 of the leaf spring 390 project from the base body 391 of the leaf spring 390 and engage the yoke 260. The arms 391 bias the yoke 260 upwardly.

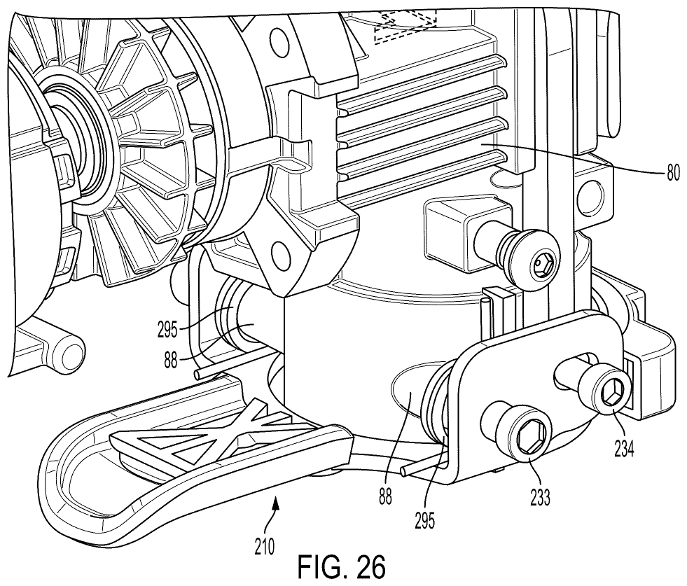

FIG. 26 illustrates an example embodiment of multiple torsion springs 295, as also shown in FIG. 10. As shown in FIG. 26 two torsion springs 295 may be included to bias the clamp lever 210 to the clamped or non-actuated position. The torsion springs 295 may be aligned with shoulder screws 233. The headbox 80 may include projections 88 and the torsion springs 295 may be around the projections 88. The projections 88 may include internal screw threads for engaging screw threads of the shoulder screws 233.

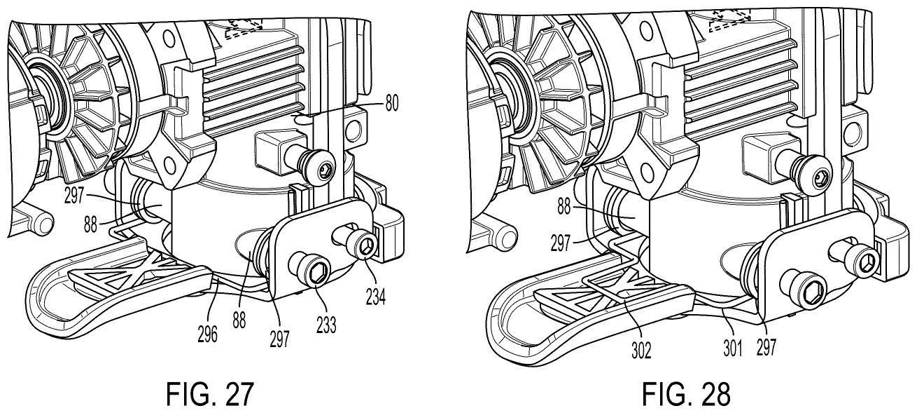

FIG. 27 illustrates an example embodiment where a single torsion spring 296 is around both sides of the projections 88. The torsion spring 296 has a pair of side sections 297 that have a circular central opening that is around the projections 88. A connecting section 298 connects the side sections.

FIG. 28 illustrates another example embodiment of a single torsion spring 301. The single torsion sprint 301 includes side sections 297. The connecting section 302 of the spring 301 projects to provide more leverage for biasing the clamp lever 210.

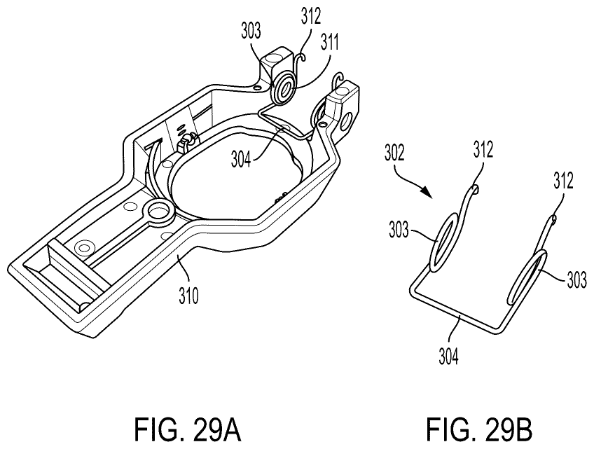

FIGS. 29A and 29B illustrate another example embodiment of a torsion spring 302. FIG. 29A illustrates the torsion spring 302 on a clamp 310 and FIG. 29B illustrates the torsion spring 302 alone. The clamp 310 would have the similar function for unclamping the blade clamp as clamp 210. The torsion spring 302 includes a pair of side sections 303 and a connection section 304. In the example embodiment of FIGS. 29A and 29B, the clamp 310 includes projections 311 and the side sections 303 fit on the projections 311 of the clamp 310. Hook projections 312 of the spring may engage the headbox 80.

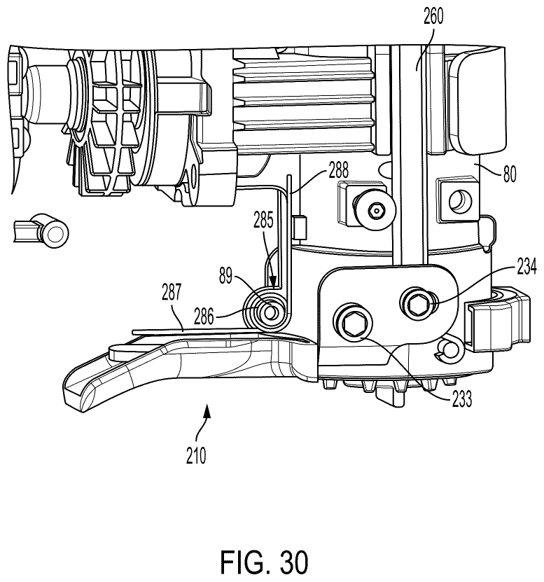

FIG. 30 illustrates an example embodiment of a mounting boss 89 on the headbox 80. The mounting boss 89 may be used for mounting a torsion spring 285. The torsion spring 285 may be a single torsion spring. In some embodiments there may be at least two mounting bosses and at least two torsion springs 285. In the example embodiment, the spring 285 has a central section 286 that is generally hollow and cylindrically shaped and surrounds the mounting boss 89. The torsion spring 285 also includes a first leg 287 biased against the headbox 80 and a second leg 288 biased against the clamp lever 210. In this manner, the spring 285 biases against a direction of actuating the clamp lever 210 (i.e., biases toward a clamped or closed position). The exemplary embodiment may also include ribs on the housing of the oscillating tool for helping to secure the spring 285 onto the boss 89 and preventing the spring 285 from becoming removed from the boss 89.

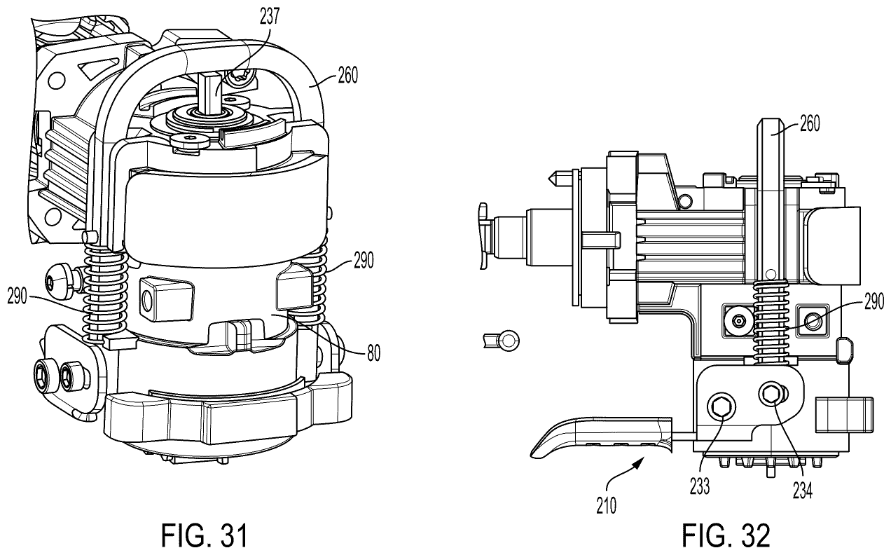

FIGS. 31 and 32 are further illustrations of spring 290 and a spring engagement pin 263. Spring 290 is disposed between the engagement pin 263 and shoulder screw 233 to bias the clamp lever 210 to the clamped or non-actuated position, as shown in FIGS. 9 and 32. In an example embodiment, there may be a spring 290 and a corresponding engagement pin 263 on each side of the yoke 260.

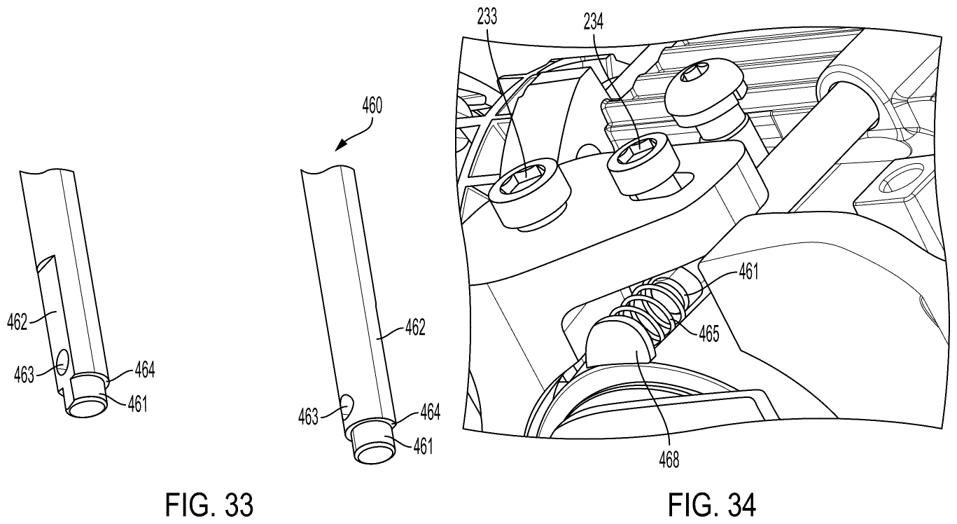

FIGS. 33 and 34 illustrate another example embodiment of biasing for a yoke. FIG. 33 illustrates another example embodiment of a yoke 460. The yoke 460 is generally the same as the yoke 266 except as otherwise shown or described. The yoke 460 has a generally circular cross-section similar to the yoke 266, but other embodiments may have flat sides such as shown with yoke 260. The yoke 460 has reduced diameter sections 461 at bottom ends thereof. The yoke 460 also includes flats 462 near the bottom ends and extending to the reduced diameter sections 461. The flats 462 engage a forward portion of the clamp lever 210 near hole 213. In particular, inward portions of the clamp lever 210 are substantially flat and the flats 462 create adjacent engaging flat parts.

A pair of holes 463 extend through the yoke 460 at locations adjacent to the reduced diameter sections 461. The holes 463 may be similar to the holes 260 and 261.

Springs 465 may be at the bottom ends of the yoke 460 around the reduced diameter section 461. The spring 465 may surround the reduced diameter section 461 and extend downwardly. The upper end of the spring 465 may be sized so that it is stopped by a shoulder 464 bounding the reduced diameter section 461. The headbox 80 may include stops 468 for engaging the lower end of the springs 465. In this manner, the springs 465 may bias the yoke 460 upwardly. As with other embodiments, the features of the embodiment of FIGS. 33 and 34 may be combined or substituted with features with other embodiments.

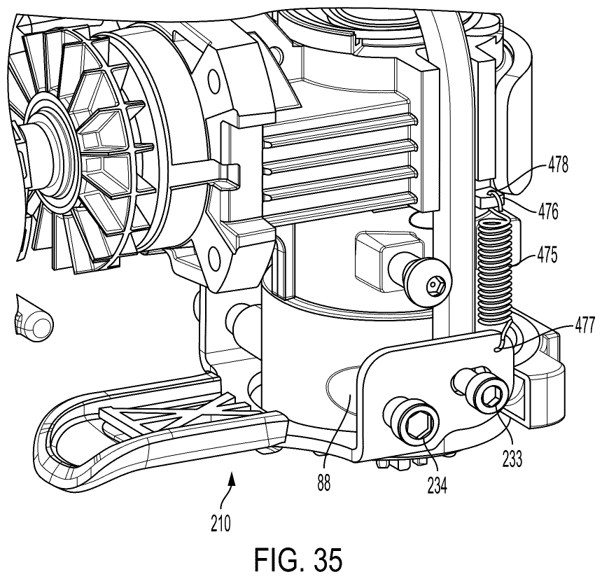

FIG. 35 illustrates an exemplary embodiment of an extension spring 475. In the example embodiment, an engagement hole 477 is added to the clamp lever 210 forward of the holes 213 on either side. Additionally, a pair of engagement projections 476 with engagement holes 478 are included with the headbox 80. The engagement projections 476 and 478 may be on both sides of the headbox 80. A bottom end of the extension spring 475 is engaged with the engagement hole 477 and a top end of the extension spring 475 is engaged with the engagement hole 478 of the engagement projection 476. In the example embodiment there are two extensions springs 475, one on either side of the headbox 80 and clamp lever 210. The engagement holes 477 are forward of the holes 233 and 212 as well as the screws 233 and 234. Because the engagement hole 477 is forward of the shoulder screw 234, it is opposite the pivot point of the lever 210 and biases the lever 210 against actuation. In the example embodiment, there are two extension springs 475. In other embodiments, there may be one extension spring or two or more extension springs.

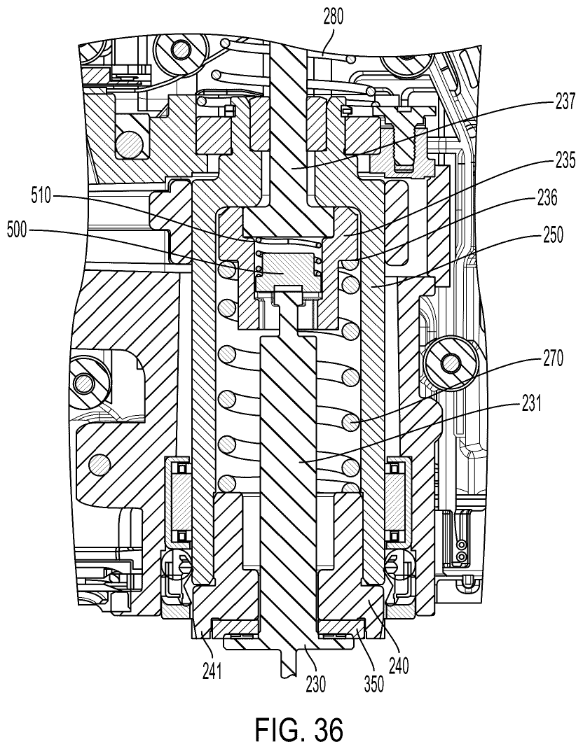

FIGS. 36-38 illustrate another exemplary embodiment including a bottom clamp internal spring. Features of the exemplary embodiment of FIGS. 36-38 may be similar to or the same as those previously described, but with the addition of an internal blade clamp spring 510 and spring keeper 500.

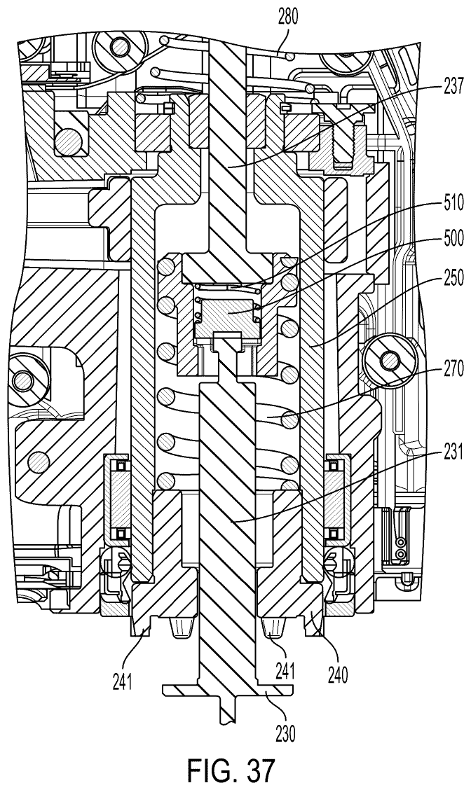

FIGS. 36-38 are cross-sectional views. FIG. 36 illustrates the blade clamp in a clamped or unactuated position in which an oscillating tool accessory 350 is clamped between top blade clamp 240 and bottom blade clamp 230. The accessory 350 is clamped with a clamping force provided by inner clamp spring 270. FIG. 37 illustrates the blade clamp in an open, unclamped or actuated position in which the bottom blade clamp 230 is moved away from the top blade clamp 240. In the open position, an oscillating tool accessory such as the oscillating tool accessory 350 with an open-ended aperture 351 may be inserted or removed. Additionally, in the open position, the blade clamp shaft 231 may be removed to allow for insertion and removal of an oscillating tool accessory without an open-ended aperture.

When in the open position, the blade clamp 230 and blade clamp shaft 231 are rotatable. Rotating the blade clamp 230 and blade clamp shaft 231 unlock the clamp 230 and shaft 231 and allow its removal. When the bottom blade clamp 230 is in the closed or clamped position, the bottom blade clamp 230 is secured and prevented from moving by the inner clamp spring 270. In the example embodiment, the blade clamp 230 and the blade clamp shaft 231 are a single integral part. In other embodiments, the blade clamp 230 and blade clamp shaft 231 may be two different parts secured together.

The example embodiment of FIGS. 36-38 includes an internal blade clamp spring 510 and a spring keeper 500 for interfacing with the internal blade clamp spring 510. The internal blade clamp spring 510 applies a biasing force through the spring keeper 500 to the blade clamp shaft 231 that keeps the blade clamp shaft 231 from lifting out and being removed when the clamp lever 210 is actuated to open the clamp. In the example embodiment of FIGS. 36-38, a user needs to push the bottom clamp 230 upwardly to overcome the spring force of the internal blade clamp spring 510 in order to rotate and remove the bottom clamp 230 and blade clamp shaft 231.

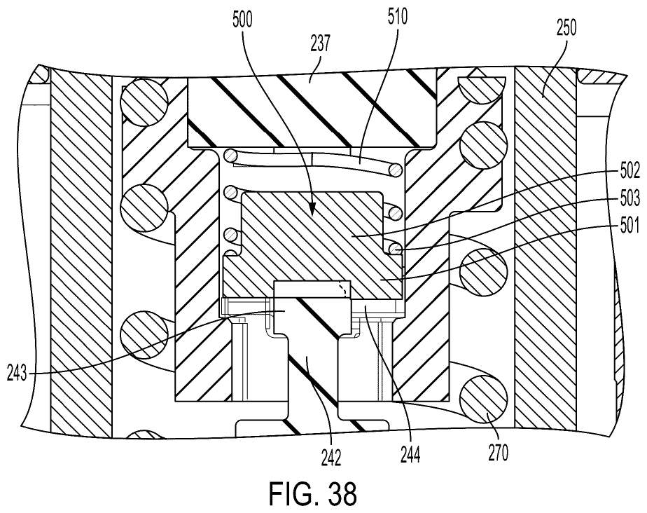

FIG. 38 is a close-up illustration of the spring keeper 500 and spring 510. As shown, the spring keeper 500 includes a first portion 501 and a second portion 502. The first portion 501 abuts a top of the blade clamp shaft 231. Each of the first portion 501 and the second portion 502 may have generally cylindrical cross-sections. The diameter of the first portion 501 may be greater than the diameter of the second portion 502. The spring 510 may be positioned around the first portion 501 and abut a shoulder 503 created by a top face of the second portion 502. A top end of the spring 510 abuts the pusher spindle 237. As shown, the spring keeper 500 and spring 510 are generally surrounded by inner connector spindle 235.

An upper end of the blade clamp shaft 231 includes a connection section including a reduced diameter portion 242 and a latching portion 243. The latching portion 243 may have a rectangular cross-section. The latching portion 243 may have a shape such that it is secured when in one orientation and releasable in another orientation. The latching portion 243 may be secured in a seat 244. The seat 244 may be formed as part of the inner connector spindle 235.

A user may actuate the clamp lever by applying a force to move the lower blade clamp 230 to an unclamped position, as shown in FIG. 11. In this position, the spring 510 biases the latching portion 243 through the keeper 500 into the seat 244. That is, the spring 510 provides a biasing force that biases the latching portion 243 into a position of engagement with the seat 244 such that the blade clamp shaft 231 remains secured to the oscillating tool 100. In this position, a user can insert or remove an oscillating accessory with an open-ended aperture and the blade clamp shaft 231 remains engaged with the tool 100. In order to remove the blade clamp shaft 231, a user may press the blade clamp shaft 231 upwardly against the biasing force of spring 510 to remove the latching portion 243 from the seat 244. The user may then rotate the clamp shaft 231. For example, the user may rotate the clamp shaft 231 roughly 90 degrees. The clamp shaft 231 may the be removed from the oscillating tool 100. An oscillating accessory can then be inserted onto the tool 100, for example at the top clamp 240 with projections 241, whether or not that accessory includes an open-ended aperture. The clamp shaft 231 can then be re-inserted into the oscillating tool 100. The clamp shaft 231 can be pressed upwardly such that the latching portion 243 opposes the biasing force of the spring 510, the clamp shaft can be rotated (for example by 90 degrees), and then the clamp shaft 231 may be released to engage the seat 244 and will be maintained in the seat by a force from the spring 510. In this manner, a user may reliably insert and remove an open-ended oscillating tool accessory without removal of the clamp shaft 231 and may reliably insert and remove an open-ended or close-ended oscillating tool accessory by removing the clamp shaft 231.

The foregoing description of the embodiments has been provided for purposes of illustration and description. It is not intended to be exhaustive or to limit the disclosure. Individual elements or features of a particular embodiment are generally not limited to that particular embodiment, but, where applicable, and can be combined, added to or exchanged with features or elements in other embodiments. The same may also be varied in many ways. Such variations are not to be regarded as a departure from the disclosure, and all such modifications are intended to be included within the scope of the disclosure.

Additionally, while exemplary embodiments are described with respect to an oscillating tool, the methods and configurations may also apply to or encompass other power tools such as other tools that hold power tools accessories.

1. A power tool, comprising:
a housing;
a motor in the housing;
a clamp assembly operatively driven by the motor in an oscillating motion about an oscillating axis, the clamp assembly comprising a first blade clamp and a second blade clamp opposing the first blade clamp, the clamp assembly configured to selectively hold a power tool accessory between the first blade clamp and the second blade clamp;
a yoke operatively coupled to the second blade clamp and configured to move the second blade clamp relative to the first blade clamp;
a clamp actuator connected to the yoke and configured to drive the yoke;
a headbox;
an output spindle at least partially disposed in the headbox;
wherein the yoke extends along a first side of the headbox and a second side of the headbox opposite the first side of the headbox.

2. The power tool of claim 1, wherein the yoke has a generally upside-down U-shape.

3. The power tool of claim 1, wherein the clamp actuator is rotatable about a pivot axis.

4. The power tool of claim 3, wherein the pivot axis is rearward of the oscillating axis.

5. The power tool of claim 1, wherein the first blade clamp is formed integrally as one piece with the output spindle.

6. The power tool of claim 1, wherein the clamp actuator is disposed at an underside of the housing.

7. The power tool of claim 1, wherein the second blade clamp is removable in a tool-free manner.

8. A power tool, comprising:
a housing;
a motor in the housing;
a clamp assembly operatively driven by the motor in an oscillating motion about an oscillating axis, the clamp assembly comprising a first blade clamp and a second blade clamp opposing the first blade clamp, the clamp assembly configured to selectively hold a power tool accessory between the first blade clamp and the second blade clamp;
a clamp lever disposed at an underside of the housing and adjacent to the clamp assembly;
wherein the clamp lever is pivotable about a pivot axis.

9. The power tool of claim 8, wherein the pivot axis is rearward of the oscillating axis.

10. The power tool of claim 8, wherein the pivot axis is perpendicular to the oscillating axis.

11. The power tool of claim 8, wherein the second blade clamp is removable in a tool-free manner.

12. A power tool, comprising:
a housing;
a motor in the housing;
a headbox at least partially in the housing;
an output spindle at least partially in the headbox;
a blade clamp shaft extending in an interior of the output spindle;
a first blade clamp associated with the output spindle;
a second blade clamp associated with the blade clamp shaft;
a yoke configured to move the second blade clamp away from the first blade clamp.

13. The power tool of claim 12, further comprising a pusher spindle between the yoke and blade clamp shaft.

14. The power tool of claim 13, further comprising a connector spindle between the pusher spindle and the blade clamp shaft, wherein motion of the yoke is transferred to the second blade clamp through the pusher spindle and the connector spindle.

15. The power tool of claim 14, further comprising a clamp spring between a portion of the output spindle and a portion of the connector spindle.

16. The power tool of claim 15, wherein the second blade clamp is removable in a tool-free manner.

17. The power tool of claim 16, further comprising a user actuatable clamp actuator configured to move the yoke.

18. The power tool of claim 17, wherein the clamp actuator comprises a clamp lever.

19. The power tool of claim 18, wherein the clamp actuator is disposed adjacent to the blade clamp.

20. The power tool of claim 17, wherein the yoke extends along a first side of the headbox, a top of the headbox, and a second side of the headbox opposite the first side of the headbox.
